(19) United States
(12) Patent Application Publication
(10) Pub. No.: US 2025/0062934 A1
(43) Pub. Date: Feb. 20, 2025

(54) INFORMATION PROCESSING SYSTEM AND NON-TRANSITORY COMPUTER-READABLE STORAGE MEDIUM

(71) Applicant: FUJIFILM Business Innovation Corp., Tokyo (JP)

(72) Inventor: Hiroshige NONAKA, Kanagawa (JP)

(73) Assignee: FUJIFILM Business Innovation Corp., Tokyo (JP)

(21) Appl. No.: 18/595,424

(22) Filed: Mar. 5, 2024

(30) Foreign Application Priority Data
Aug. 18, 2023 (JP) 2023-133391

(51) Int. Cl. H04L 12/66; H04L 69/18

(52) U.S. Cl. CPC H04L 12/66; H04L 69/18

(57) ABSTRACT

An information processing system includes at least one processor, wherein the at least one processor receives a request to register a transmission destination of data by using any of a plurality of network interfaces, and performs registration processing for registering a network interface used for reception of a request to register a specific transmission destination among the plurality of network interfaces as a network interface to be used for transmission of data to the specific transmission destination.

### CROSS-REFERENCE TO RELATED APPLICATIONS

This application is based on and claims priority under 35 USC 119 from Japanese Patent Application No. 2023-133391 filed Aug. 18, 2023.

### BACKGROUND

### (i) Technical Field

The present invention relates to an information processing system and a non-transitory computer-readable storage medium.

### (ii) Related Art

JP2019-36059A describes an information processing apparatus including a plurality of network interfaces used for communication with an external apparatus, an acquisition unit that acquires a communication request to the external apparatus based on an input operation of a user, and a selection unit that selects a network interface used for communication with the external apparatus from among the plurality of network interfaces based on related information related to a user who is a request source of the acquired communication request.

### SUMMARY

A network interface to be used for transmission of data to a transmission destination is registered in advance in some cases. In such a case, for example, a configuration is conceivable in which a network interface selected by a user is registered. However, when such a configuration is adopted, there is a possibility that transmission of data to a transmission destination is not accurately performed.

Aspects of non-limiting embodiments of the present disclosure relate to an information processing system that increases the possibility of accurate transmission of data to a transmission destination as compared with a case where a configuration is adopted in which a network interface selected by a user is registered as a network interface to be used for transmission of data to a transmission destination.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising at least one processor, wherein the at least one processor receives a request to register a transmission destination of data by using any of a plurality of network interfaces, and performs registration processing for registering a network interface used for reception of a request to register a specific transmission destination among the plurality of network interfaces as a network interface to be used for transmission of data to the specific transmission destination.

### BRIEF DESCRIPTION OF THE DRAWINGS

Exemplary embodiments of the present invention will be described in detail based on the following figures, wherein:

FIG. 1 is a diagram illustrating an example of the overall configuration of an image processing system according to the present exemplary embodiment;

FIG. 2 is a diagram illustrating an example of a hardware configuration of an image processing apparatus according to the present exemplary embodiment;

FIG. 3 is a diagram schematically illustrating destination registration processing of the image processing system according to a first exemplary embodiment;

FIG. 4 is a block diagram illustrating an example of a functional configuration of an image processing apparatus according to the first exemplary embodiment;

FIG. 5 is a flowchart illustrating an operation example of the image processing apparatus according to the first exemplary embodiment;

FIG. 6 is a diagram schematically illustrating destination registration processing of the image processing system according to a second exemplary embodiment;

FIG. 7 is a block diagram illustrating an example of a functional configuration of an image processing apparatus according to the second exemplary embodiment;

FIG. 8 is a flowchart illustrating an operation example of the image processing apparatus according to the second exemplary embodiment;

FIG. 9 is a diagram schematically illustrating destination registration processing of the image processing system according to a third exemplary embodiment;

FIG. 10 is a block diagram illustrating an example of a functional configuration of an image processing apparatus according to the third exemplary embodiment;

FIG. 11 is a flowchart illustrating an operation example of the image processing apparatus according to the third exemplary embodiment;

FIG. 12 is a diagram schematically illustrating destination registration processing of an image processing system according to a fourth exemplary embodiment;

FIG. 13 is a block diagram illustrating an example of a functional configuration of an image processing apparatus according to the fourth exemplary embodiment;

FIG. 14 is a flowchart illustrating an operation example of the image processing apparatus according to the fourth exemplary embodiment; and

FIGS. 15A and 15B are diagrams illustrating a specific example of an address book in a modification example.

### DETAILED DESCRIPTION

Hereinafter, the present exemplary embodiment will be described in detail with reference to the accompanying drawings.

### Outline of the Present Exemplary Embodiment

The present exemplary embodiment provides an information processing system that receives a request to register a transmission destination of data by using any of a plurality of network interfaces, and performs registration processing for registering a network interface used for reception of a request to register a specific transmission destination among the plurality of network interfaces as a network interface to be used for transmission of data to the specific transmission destination.

Here, the “system” may be configured by a single apparatus, or may be configured by a plurality of apparatuses. In the following description, an information processing system configured by a single apparatus will be described as an example, and an image processing apparatus will be described as an example of the single apparatus.

The image processing apparatus may have various kinds of information such as an address book and a processing instruction definition as a target for registration of a transmission destination of data. The address book is information including user names and destinations of a plurality of users. The processing instruction definition is information that defines a processing procedure, a processing parameter, a transmission parameter, and the like for processing to be repeatedly executed. Hereinafter, an address book will be described as an example of a target for registration of a transmission destination of data.

### [Overall Configuration of Image Processing System]

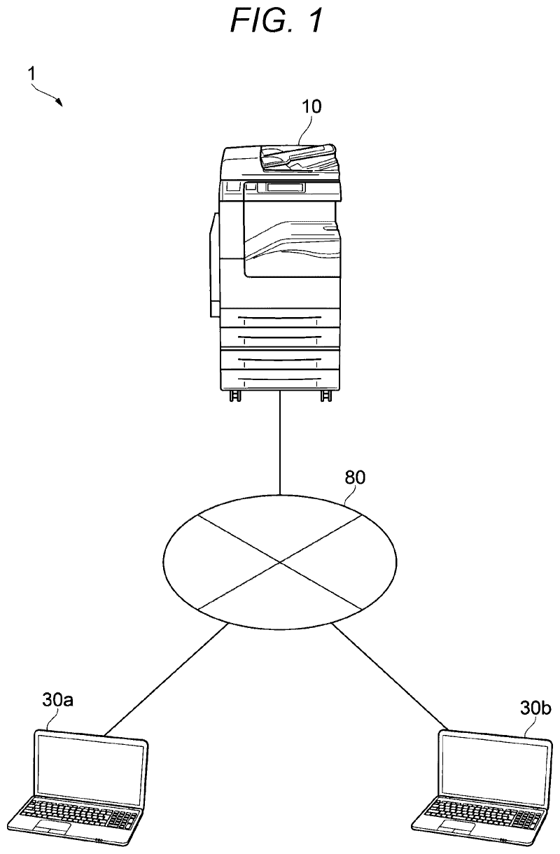

FIG. 1 is a diagram illustrating an example of the overall configuration of an image processing system 1 according to the present exemplary embodiment. As illustrated in the figure, the image processing system 1 is configured by connecting an image processing apparatus 10 and terminal apparatuses 30a and 30b via a communication line 80. Although the terminal apparatuses 30a and 30b are illustrated in the figure, they may be referred to as the terminal apparatus 30 when they do not need to be distinguished from each other.

The image processing apparatus 10 is an apparatus that performs image processing such as image formation on a recording medium such as paper, image reading from a recording medium such as paper, image transmission to a public line, and image reception from a public line. The image processing apparatus 10 is a printer from the viewpoint of performing only image formation, is a copy machine from the viewpoint of performing image reading and image formation, and is a facsimile from the viewpoint of performing image reading and image transmission or image reception and image formation. The image processing apparatus 10 includes an address book and is capable of transmitting data that has been acquired or held by the apparatus to a transmission destination registered on the address book. Although the figure illustrates only one image processing apparatus 10, a plurality of image processing apparatuses 10 may be present.

The terminal apparatus 30 is a computer used by a user. The terminal apparatus 30 can instruct the image processing apparatus 10 to perform image processing such as image formation on a recording medium such as paper, image reading from a recording medium such as paper, image transmission to a public line, and image reception from a public line. The terminal apparatus 30 can, for example, connect to the image processing apparatus 10 by using a web browser and change an already registered transmission destination, delete an already registered transmission destination, or register a new transmission destination on the address book of the image processing apparatus 10. As the terminal apparatus 30, for example, a desktop PC, a notebook PC, a mobile information terminal, or the like may be used. Although two terminal apparatuses 30 are illustrated in the figure, three or more terminal apparatuses 30 may be present.

The communication line 80 is a line used for information communication between the image processing apparatus 10 and the terminal apparatus 30. As the communication line 80, for example, the Internet may be used.

### [Hardware Configuration of Image Processing Apparatus]

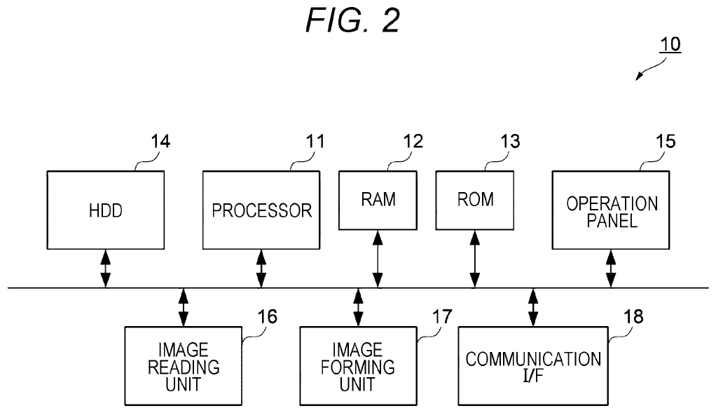

FIG. 2 is a diagram illustrating an example of a hardware configuration of the image processing apparatus 10 according to the present exemplary embodiment. As illustrated in the figure, the image processing apparatus 10 includes a processor 11, a random access memory (RAM) 12, a read only memory (ROM) 13, a hard disk drive (HDD) 14, an operation panel 15, an image reading unit 16, an image forming unit 17, and a communication interface (I/F) 18. The processor 11 realizes each function described later by loading various programs stored in the ROM 13 or the like into the RAM 12 and executing the programs.

The RAM 12 is a memory used as a working memory or the like of the processor 11.

The ROM 13 is a memory that stores various programs to be executed by the processor 11.

The HDD 14 is, for example, a magnetic disk device that stores image date read by the image reading unit 16, image date used for image formation in the image forming unit 17, and the like.

The operation panel 15 is, for example, a touch panel that displays various kinds of information and receives operation input from the user. Here, the operation panel 15 includes a display on which various kinds of information are displayed and a position detection sheet for detecting the position indicated by an indication method such as a finger or a stylus pen. Alternatively, a display and a keyboard may be used instead of the touch panel.

The image reading unit 16 reads an image recorded on a recording medium such as paper. Here, the image reading unit 16 is, for example, a scanner, and a CCD type in which reflected light of light emitted from a light source to a document is reduced by a lens and received by charge coupled devices (CCD) or a CIS type in which reflected light of light sequentially emitted from LED light sources to a document is received by a contact image sensor (CIS) may be used.

The image forming unit 17 forms an image on a recording medium such as paper. Here, the image forming unit 17 is, for example, a printer, and an electrophotographic method in which a toner adhered to a photoreceptor is transferred onto a recording medium to form an image, or an inkjet method in which ink is ejected onto a recording medium to form an image may be used.

The communication I/F 18 transmits and receives various kinds of information to and from another apparatus, for example, the terminal apparatus 30 via the communication line 80.

### [Problems in Image Processing Apparatus]

For example, in a public facility, a shared office, or the like, a plurality of networks may be physically divided and operated according to their purposes, the affiliations of users, and the like. In such an environment, when the image processing apparatus 10 including a plurality of network interfaces respectively corresponding to a plurality of networks is used to transmit, for example, read data read by the image reading unit 16, it is necessary to determine which network interface is to be used. That is, when the image processing apparatus 10 having a plurality of network interfaces transmits data by E-mail, server message block (SMB), file transfer protocol (FTP), or the like, it takes time and effort to select a network interface to be used from among them.

To save such time and effort, a configuration is conceivable in which a network interface to be used is associated with an authenticated user who uses the image processing apparatus 10. However, for a user who can use a plurality of network interfaces or an unauthenticated user, it still takes time and effort to select a network interface to be used.

On the other hand, when the network interface cannot be associated with the authenticated user or when the operation is performed in an unauthenticated mode (without authentication), having a configuration in which the network interface to be used is associated with the destination in the address book that stores the transmission destination of the read data can save time and effort for selecting the network interface at the time of transmission.

However, although such a configuration can save time and effort for selecting a network interface at the time of transmission, it still takes time and effort for a registrant to select a network interface to be used when registering a network interface in a destination. In addition, since the registrant selects a network interface, a selection error may occur.

Here, when a destination is registered via a network, the image processing apparatus 10 can distinguish an accessed network interface. Thus, in the present exemplary embodiment, when the image processing apparatus 10 identifies an accessed network interface and registers a destination, the identified network interface is registered, thereby saving time and effort for the above-described selection of a network interface. In addition, registering the network interface identified by the image processing apparatus 10 reduces selection errors of a network interface and suppresses the occurrence of a situation in which data transmission to a transmission destination is not accurately performed.

### First Exemplary Embodiment (Overview

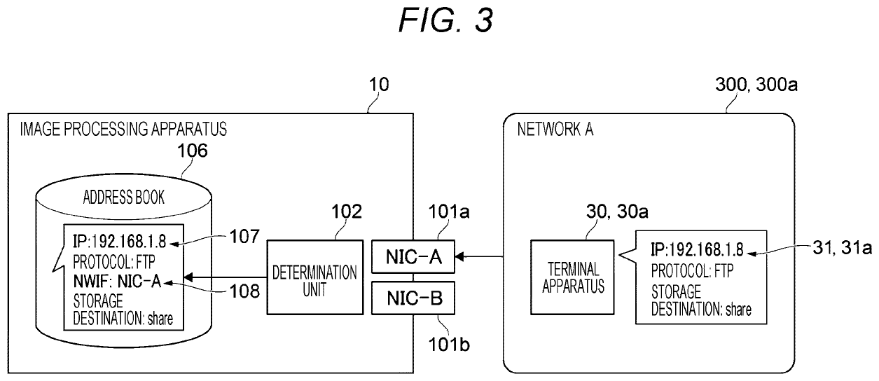

FIG. 3 is a diagram schematically illustrating destination registration processing of the image processing system 1 according to a first exemplary embodiment.

The image processing system 1 according to the first exemplary embodiment includes an image processing apparatus 10 having a plurality of network interfaces and a plurality of networks 300 respectively connected to the image processing apparatus 10 via the plurality of network interfaces. The plurality of networks 300 are independent of each other, and each terminal apparatus 30 is connected to any of the plurality of independent networks 300.

In the example of the drawing, the image processing apparatus 10 includes a plurality of network interface cards (NIC) 101, the network 300a is connected to an NIC 101a (NIC-A), and a network 300b (not illustrated) is connected to an NIC 101b (NIC-B). The network 300a and the network 300b (not illustrated) are independent of each other.

In the image processing system 1 according to the first exemplary embodiment, the terminal apparatus 30 remotely registers a destination 31 on an address book 106 of the image processing apparatus 10 via a network. At this time, in the image processing apparatus 10, the determination unit 102 can identify the accessed NIC 101, and thus the identified NIC 101 is registered in association with the destination 31.

In the example in the figure, the user accesses the image processing apparatus 10 from the terminal apparatus 30a in the network 300a (network A), and registers, on the address book 106, a destination 31a to which the document read by the image reading unit 16 (see FIG. 2) or the like is to be transmitted. At this time, in the image processing apparatus 10, the determination unit 102 determines that the NIC-A has been accessed, and registers the use of the NIC-A in a network interface description 108 corresponding to a destination description 107 in the address book 106.

### (Functional Configuration of Image Processing Apparatus)

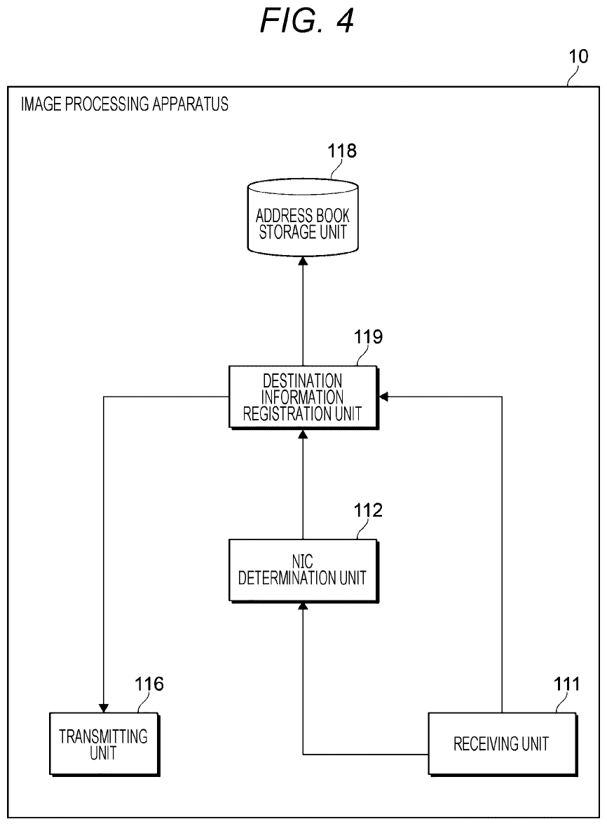

FIG. 4 is a block diagram illustrating an example of a functional configuration of the image processing apparatus 10 according to the first exemplary embodiment. As illustrated in the figure, the image processing apparatus 10 according to the first exemplary embodiment includes a receiving unit 111, an NIC determination unit 112, a transmission unit 116, an address book storage unit 118, and a destination information registration unit 119.

The receiving unit 111 receives, from the terminal apparatus 30, a destination registration request to request registration of a destination on the address book stored in the address book storage unit 118. At this time, the terminal apparatus 30 transmits the destination registration request to the image processing apparatus 10 by accessing the NIC to which the network including the terminal apparatus 30 is connected among the plurality of NICs included in the image processing apparatus 10. Thus, the receiving unit 111 receives the destination registration request by using the accessed NIC. In the present exemplary embodiment, the processing in the receiving unit 111 is performed as an example of receiving a request to register a transmission destination of data using any of a plurality of network interfaces.

The NIC determination unit 112 determines an NIC accessed when the receiving unit 111 receives a destination registration request. The NIC determination unit 112 may make such a determination by using an existing technology.

When the registration of the destination on the address book stored in the address book storage unit 118 is completed, the transmission unit 116 transmits the completion of the registration to the terminal apparatus 30 that has transmitted the destination registration request.

The address book storage unit 118 stores an address book including information of a user name, a destination, and an NIC.

The destination information registration unit 119 creates destination information by setting, for a destination included in the destination registration request received by the receiving unit 111, information of an NIC to be used when data is transmitted to the destination, and registers the destination information on the address book stored in the address book storage unit 118. Specifically, the destination information registration unit 119 sets, for the destination, the information on the NIC determined by the NIC determination unit 112 as the information of the NIC to be used when data is transmitted to the destination, and registers the destination information. In the present exemplary embodiment, the processing in the destination information registration unit 119 is performed as an example of performing (first) registration processing for registering a network interface used for reception of a request to register a specific transmission destination among a plurality of network interfaces as a network interface to be used for transmission of data to a specific transmission destination.

### (Operation of Image Processing Apparatus)

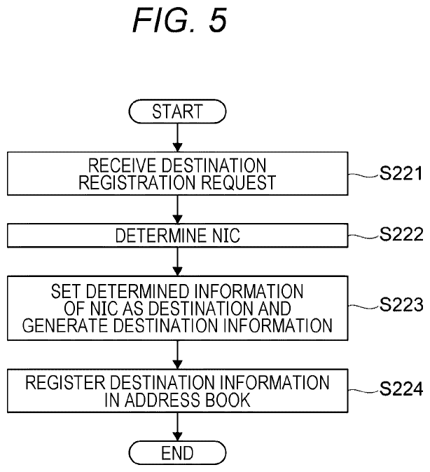

FIG. 5 is a flowchart illustrating an operation example of the image processing apparatus 10 according to the first exemplary embodiment.

In the image processing apparatus 10, first, the receiving unit 111 receives, from the terminal apparatus 30, a destination registration request to request registration of a destination on the address book stored in the address book storage unit 118 (step 221).

Then, the NIC determination unit 112 determines the NIC accessed when the destination registration request is received in step 221 (step 222).

Thus, the destination information registration unit 119 creates destination information by setting the information of the NIC determined in step 222 to the destination included in the destination registration request received in step 221 (step 223).

Thereafter, the destination information registration unit 119 registers the destination information created in step 223 on the address book stored in the address book storage unit 118 (step 224).

### Second Exemplary Embodiment (Overview

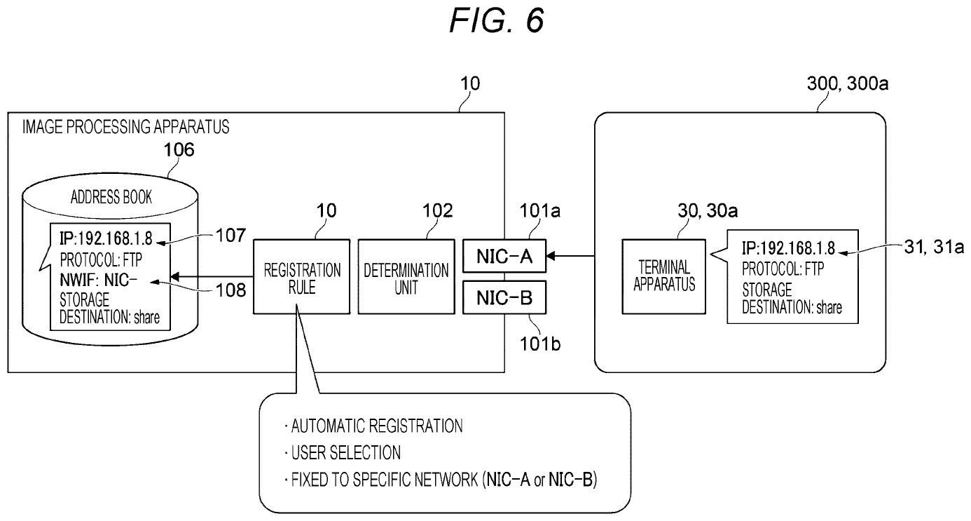

FIG. 6 is a diagram schematically illustrating destination registration processing of the image processing system 1 according to a second exemplary embodiment.

An administrator of the image processing apparatus 10 or a user who can use a plurality of network interfaces included in the image processing apparatus 10 may want to select one of the networks when remotely registering the destination 31 using the terminal apparatus 30.

As such, in the image processing system 1 according to the second exemplary embodiment, the image processing apparatus 10 sets any of “automatic registration”, “user selection”, and “fixed to specific network” as a network registration rule 103. When the registration rule 103 is “automatic registration”, the image processing apparatus 10 executes the destination registration processing of the first exemplary embodiment. When the registration rule 103 is “user selection”, the image processing apparatus 10 registers the NIC 101 selected with the terminal apparatus 30 by the user. At this time, the image processing apparatus 10 may display, on the terminal apparatus 30, the information of the NIC 101 accessed at the time of registration of the destination 31 as a default value to save the time and effort of the user to perform registration. When the registration rule 103 is “fixed to specific network”, the image processing apparatus 10 forcibly registers the NIC 101 to which a specific network is connected.

### (Functional Configuration of Image Processing Apparatus)

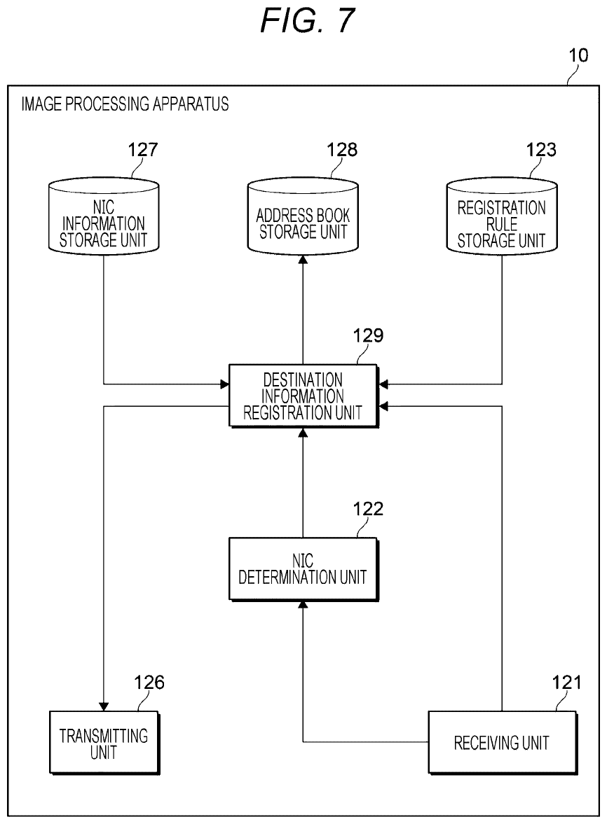

FIG. 7 is a block diagram illustrating an example of a functional configuration of the image processing apparatus 10 according to the second exemplary embodiment. As illustrated in the drawing, the image processing apparatus 10 according to the second exemplary embodiment includes a receiving unit 121, an NIC determination unit 122, a registration rule storage unit 123, a transmission unit 126, an NIC information storage unit 127, an address book storage unit 128, and a destination information registration unit 129.

The receiving unit 121 has the same function as the receiving unit 111 in the first exemplary embodiment. In the present exemplary embodiment, the processing in the receiving unit 121 is performed as an example of receiving a request to register a transmission destination of data using any of a plurality of network interfaces.

In addition to this, the receiving unit 121 receives the information of the NIC selected by the user on the NIC selection screen displayed on the terminal apparatus 30. Here, the NIC selection screen is a screen for selecting an NIC that the user wants to register from among a plurality of NICs included in the image processing apparatus 10.

The NIC determination unit 122 has the same function as the NIC determination unit 112 in the first exemplary embodiment.

The registration rule storage unit 123 stores a registration rule to be used when destination information including a destination and information of an NIC is registered on the address book stored in the address book storage unit 128. Here, as described above, the registration rules include “automatic registration”, “user selection”, and “fixed to specific network”.

The transmission unit 126 has the same function as the transmission unit 116 in the first exemplary embodiment.

In addition, when the registration rule stored in the registration rule storage unit 123 is “user selection”, the transmission unit 126 transmits a command to display the NIC selection screen to the terminal apparatus 30 that has transmitted the destination registration request.

The NIC information storage unit 127 stores information of an NIC to be included in destination information to be registered on the address book stored in the address book storage unit 128 when the registration rule stored in the registration rule storage unit 123 is “fixed to specific network”. Here, the information of the NIC is information of the NIC to which the specific network is connected.

The address book storage unit 128 has the same function as the address book storage unit 118 in the first exemplary embodiment.

The destination information registration unit 129 creates destination information by setting, for a destination included in the destination registration request received by the receiving unit 121, information of an NIC to be used when data is transmitted to the destination, and registers the destination information on the address book stored in the address book storage unit 128.

For example, it is assumed that the registration rule stored in the registration rule storage unit 123 is “automatic registration”. In this case, the destination information registration unit 129 sets, for the destination, the information of the NIC determined by the NIC determination unit 122 as the information of the NIC to be used when data is transmitted to the destination, and registers the destination information. In the present exemplary embodiment, this processing in the destination information registration unit 129 is performed as an example of performing the (first) registration processing when an instruction to perform the (first) registration processing is given.

It is also assumed that the registration rule stored in the registration rule storage unit 123 is other than “automatic registration”. In this case, the destination information registration unit 129 sets, for the destination, information of another NIC as information of the NIC to be used when data is transmitted to the destination, and registers the destination information. In the present exemplary embodiment, this processing in the destination information registration unit 129 is performed as an example of performing the second registration processing when an instruction to perform the second registration processing different from the (first) registration processing is given.

Here, various registration rules other than “automatic registration” are conceivable, but in the following description, as described above, “user selection” and “fixed to specific network” are considered.

First, it is assumed that the registration rule stored in the registration rule storage unit 123 is “user selection”. In this case, the destination information registration unit 129 sets, for the destination, the information of the NIC selected by the user and received by the receiving unit 121 as the information of the NIC to be used when data is transmitted to the destination, and registers the destination information. In the present exemplary embodiment, this processing in the destination information registration unit 129 is performed as an example of performing the second registration processing for registering the network interface selected by the user in the request to register the specific transmission destination among the plurality of network interfaces as the network interface to be used for transmission of data to a specific transmission destination.

It is assumed that the registration rule stored in the registration rule storage unit 123 is “fixed to specific network”. In this case, the destination information registration unit 129 sets, for the destination, the information of the NIC stored in the NIC information storage unit 127 as the information of the NIC to be used when data is transmitted to the destination, and registers the destination information. In the present exemplary embodiment, this processing in the destination information registration unit 129 is performed as an example of performing the second registration processing for registering a predetermined network interface among a plurality of network interfaces as a network interface to be used for transmission of data to a specific transmission destination.

### (Operation of Image Processing Apparatus)

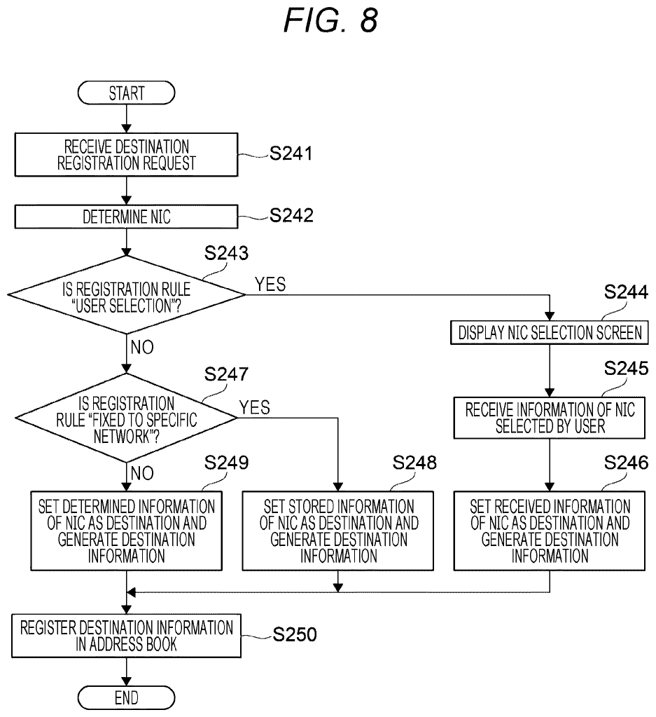

FIG. 8 is a flowchart illustrating an operation example of the image processing apparatus 10 according to the second exemplary embodiment.

In the image processing apparatus 10, first, the receiving unit 121 receives, from the terminal apparatus 30, a destination registration request to request registration of a destination on the address book stored in the address book storage unit 128 (step 241).

Then, the NIC determination unit 122 determines the NIC accessed when the destination registration request is received in step 241 (step 242).

Next, the destination information registration unit 129 determines whether the registration rule stored in the registration rule storage unit 123 is “user selection” (step 243).

It is assumed that it is determined in step 243 that the registration rule is “user selection”. In this case, the transmission unit 126 transmits a command to display the NIC selection screen to the terminal apparatus 30 that has transmitted the destination registration request (step 244). Then, the receiving unit 121 receives the information of the NIC selected by the user on the NIC selection screen displayed on the terminal apparatus 30 (step 245). Thereafter, the destination information registration unit 129 creates destination information by setting the information of the NIC received in step 245 to the destination included in the destination registration request received in step 241 (step 246).

On the other hand, it is assumed that it is determined in step 243 that the registration rule is not “user selection”. In such a case, the destination information registration unit 129 determines whether the registration rule is “fixed to specific network” (step 247).

It is assumed that it is determined in step 247 that the registration rule is “fixed to specific network”. In such a case, the destination information registration unit 129 creates destination information by setting the information of the NIC stored in the NIC information storage unit 127 to the destination included in the destination registration request received in step 241 (step 248).

On the other hand, it is assumed that it is determined in step 248 that the registration rule is not “fixed to specific network”. In such a case, the destination information registration unit 129 creates destination information by setting the information of the NIC determined in step 242 to the destination included in the destination registration request received in step 241 (step 249).

Thereafter, the destination information registration unit 129 registers the destination information created in step 246, step 248, or step 249 on the address book stored in the address book storage unit 128 (step 250).

### Third Exemplary Embodiment (Overview

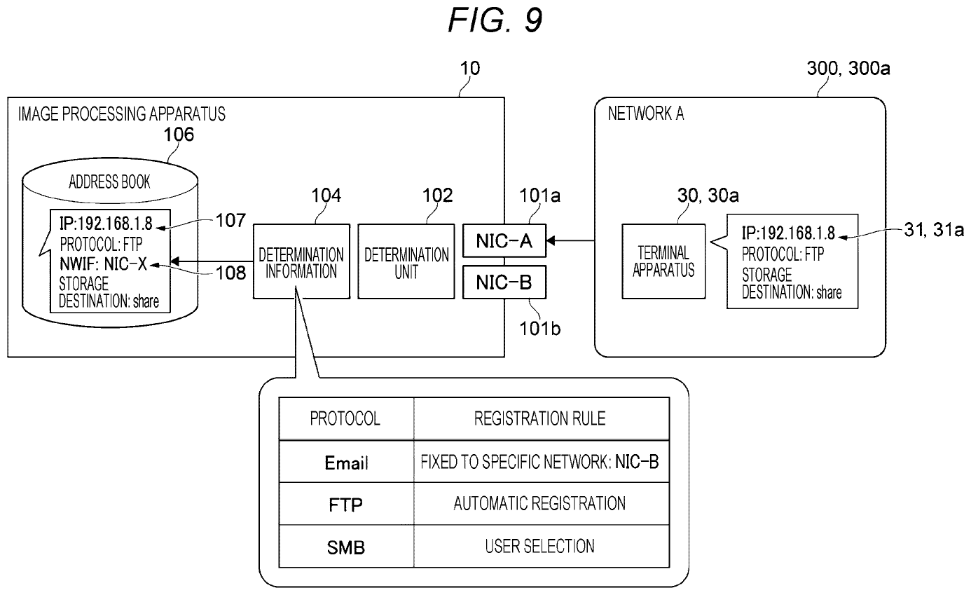

FIG. 9 is a diagram schematically illustrating destination registration processing of the image processing system 1 according to a third exemplary embodiment.

Depending on the protocol used when data is transmitted via a network, there is a case where only a specific network may be usable. For example, there is a case where data is transmitted by E-mail in an environment where only a specific network among a plurality of networks has a mail server. In such a case, the user may want to select a network interface of a specific network.

As such, in the image processing system 1 according to the third exemplary embodiment, the image processing apparatus 10 sets determination information 104 for determining whether the network registration rule for the protocol is “automatic registration”, “user selection”, or “fixed to specific network”. In the illustrated example, the registration rule “fixed to specific network” is selected for the protocol “Email”, and the network 300b (network B) connected to the NIC-B is selected as the specific network. In addition, the registration rule “automatic registration” is selected for the protocol “FTP”, and the registration rule “user selection” is selected for the protocol “SMB”. That is, the image processing apparatus 10 individually sets and manages the registration rule depending on the protocol.

### (Functional Configuration of Image Processing Apparatus)

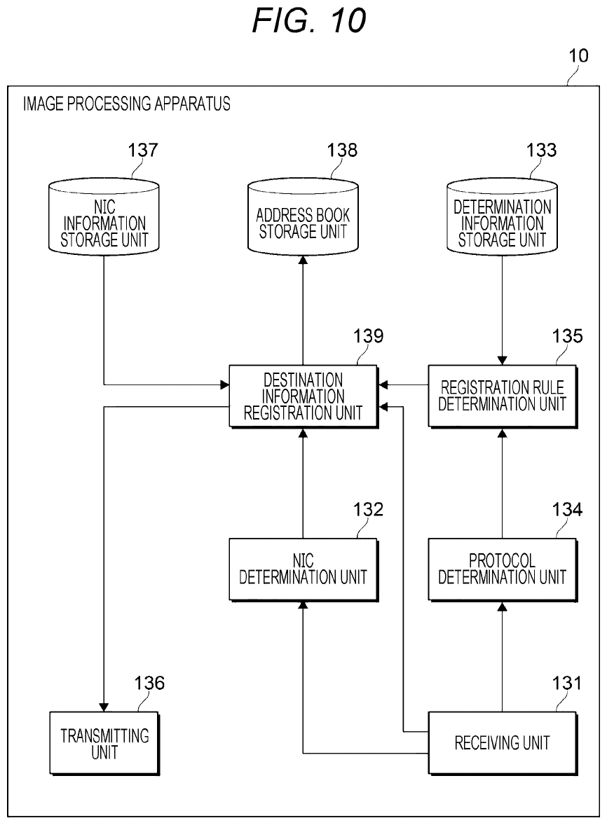

FIG. 10 is a block diagram illustrating an example of a functional configuration of the image processing apparatus 10 according to the third exemplary embodiment. As illustrated in the drawing, the image processing apparatus 10 includes a receiving unit 131, an NIC determination unit 132, a determination information storage unit 133, a protocol determination unit 134, a registration rule determination unit 135, a transmission unit 136, an NIC information storage unit 137, an address book storage unit 138, and a destination information registration unit 139.

The receiving unit 131 has the same function as the receiving unit 111 in the first exemplary embodiment. In the present exemplary embodiment, the processing in the receiving unit 131 is performed as an example of receiving a request to register a transmission destination of data using any of a plurality of network interfaces.

In addition to this, the receiving unit 131 receives information of the NIC selected by the user on the NIC selection screen displayed on the terminal apparatus 30. Here, the NIC selection screen is a screen for selecting an NIC that the user wants to register from among a plurality of NICs included in the image processing apparatus 10.

The NIC determination unit 132 has the same function as the NIC determination unit 112 in the first exemplary embodiment.

The determination information storage unit 133 stores determination information for determining the registration rule used when destination information including a destination and information of an NIC is registered on the address book stored in the address book storage unit 138. Here, as described above, the registration rules include “automatic registration”, “user selection”, and “fixed to specific network”.

The protocol determination unit 134 determines a protocol used when data is transmitted to the destination included in the destination registration request received by the receiving unit 131. Here, the protocol may be determined based on information designated by the user, or may be determined based on a feature of a character string representing the destination. In the present exemplary embodiment, the processing in the protocol determination unit 134 is performed as an example of identifying a protocol to be used for transmission of data to a specific transmission destination.

The registration rule determination unit 135 determines the registration rule by searching the determination information stored in the determination information storage unit 133 using the protocol determined by the protocol determination unit 134.

The transmission unit 136 has the same function as the transmission unit 116 in the first exemplary embodiment.

In addition, when the registration rule determined by the registration rule determination unit 135 is “user selection”, the transmission unit 136 transmits a command to display the NIC selection screen to the terminal apparatus 30 that has transmitted the destination registration request.

The address book storage unit 138 has the same function as the address book storage unit 118 in the first exemplary embodiment.

The destination information registration unit 139 creates destination information by setting, for the destination included in the destination registration request received by the receiving unit 131, information of the NIC to be used when data is transmitted to the destination, and registers the destination information on the address book stored in the address book storage unit 138.

For example, it is assumed that the registration rule determined by the registration rule determination unit 135 is “automatic registration”. In this case, the destination information registration unit 139 sets, for the destination, the information of the NIC determined by the NIC determination unit 132 as the information of the NIC to be used when data is transmitted to the destination, and registers the destination information. In the present exemplary embodiment, this processing in the destination information registration unit 139 is performed as an example of performing the (first) registration processing when the protocol is a first protocol.

It is also assumed that the registration rule determined by the registration rule determination unit 135 is other than “automatic registration”. In this case, the destination information registration unit 139 sets, for the destination, information of another NIC as information of the NIC to be used when data is transmitted to the destination, and registers the destination information. In the present exemplary embodiment, this processing in the destination information registration unit 139 is performed as an example of performing the second registration processing different from the registration processing when the protocol is a second protocol different from the first protocol.

Here, various registration rules other than “automatic registration” are conceivable, but also in the following description, as described above, “user selection” and “fixed to specific network” are considered.

First, it is assumed that the registration rule determined by the registration rule determination unit 135 is “user selection”. In this case, the destination information registration unit 139 sets, for the destination, the information of the NIC selected by the user and received by the receiving unit 131 as the information of the NIC to be used when data is transmitted to the destination, and registers the destination information. In the present exemplary embodiment, this processing in the destination information registration unit 139 is performed as an example of performing the second registration processing for registering the network interface selected by the user in the request to register the specific transmission destination among a plurality of network interfaces as the network interface to be used for transmission of data to the specific transmission destination.

It is also assumed that the registration rule determined by the registration rule determination unit 135 is “fixed to specific network”. In this case, the destination information registration unit 139 sets, for the destination, the information of the NIC stored in the NIC information storage unit 137 as the information of the NIC to be used when data is transmitted to the destination, and registers the destination information. In the present exemplary embodiment, this processing in the destination information registration unit 139 is performed as an example of performing the second registration processing for registering a predetermined network interface among a plurality of network interfaces as a network interface to be used for transmission of data to a specific transmission destination.

### (Operation of Image Processing Apparatus)

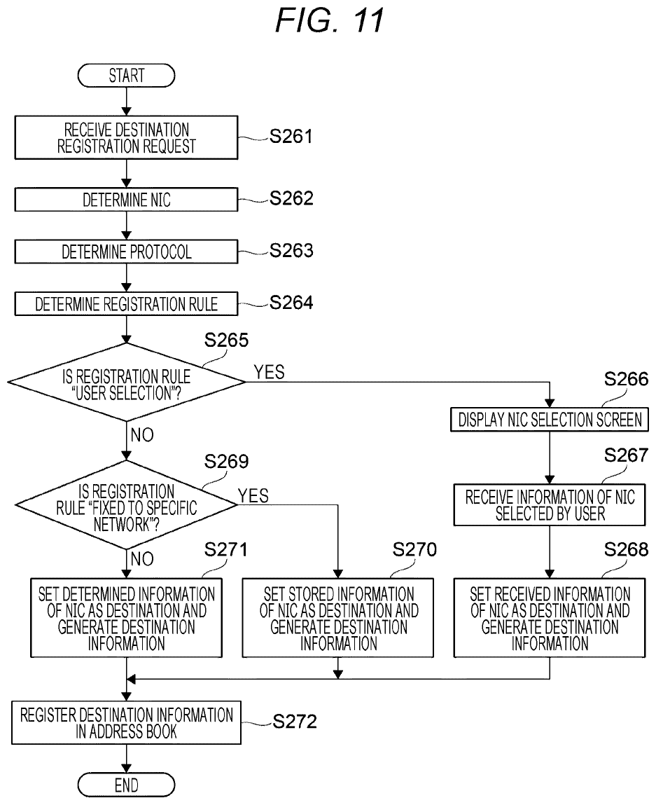

FIG. 11 is a flowchart illustrating an operation example of the image processing apparatus 10 according to the third exemplary embodiment.

In the image processing apparatus 10, first, the receiving unit 131 receives, from the terminal apparatus 30, a destination registration request to request registration of a destination on the address book stored in the address book storage unit 138 (step 261).

Then, the NIC determination unit 132 determines the NIC accessed when the destination registration request is received in step 261 (step 262).

Next, the protocol determination unit 134 determines the protocol used when data is transmitted to the destination included in the destination registration request received in step 261 (step 263).

Thus, the registration rule determination unit 135 determines the registration rule by searching the determination information stored in the determination information storage unit 133 by using the protocol determined in step 263 (step 264).

Next, the destination information registration unit 139 determines whether the registration rule determined in step 264 is “user selection” (step 265).

It is assumed that it is determined in step 265 that the registration rule is “user selection”. In this case, the transmission unit 136 transmits a command to display the NIC selection screen to the terminal apparatus 30 that has transmitted the destination registration request (step 266). Then, the receiving unit 131 receives information of the NIC selected by the user on the NIC selection screen displayed on the terminal apparatus 30 (step 267). Thereafter, the destination information registration unit 139 creates destination information by setting the information on the NIC received in step 267 to the destination included in the destination registration request received in step 261 (step 268).

On the other hand, it is assumed that it is determined in step 265 that the registration rule is not “user selection”. In such a case, the destination information registration unit 139 determines whether the registration rule is “fixed to specific network” (step 269).

It is assumed that it is determined in step 269 that the registration rule is “fixed to specific network”. In such a case, the destination information registration unit 139 creates destination information by setting the information of the NIC stored in the NIC information storage unit 137 to the destination included in the destination registration request received in step 261 (step 270).

On the other hand, it is assumed that it is determined in step 269 that the registration rule is not “fixed to specific network”. In such a case, the destination information registration unit 139 creates destination information by setting the information of the NIC determined in step 262 to the destination included in the destination registration request received in step 261 (step 271).

Thereafter, the destination information registration unit 139 registers the destination information created in step 268, step 270, or step 271 on the address book stored in the address book storage unit 138 (step 272).

### Fourth Exemplary Embodiment (Overview

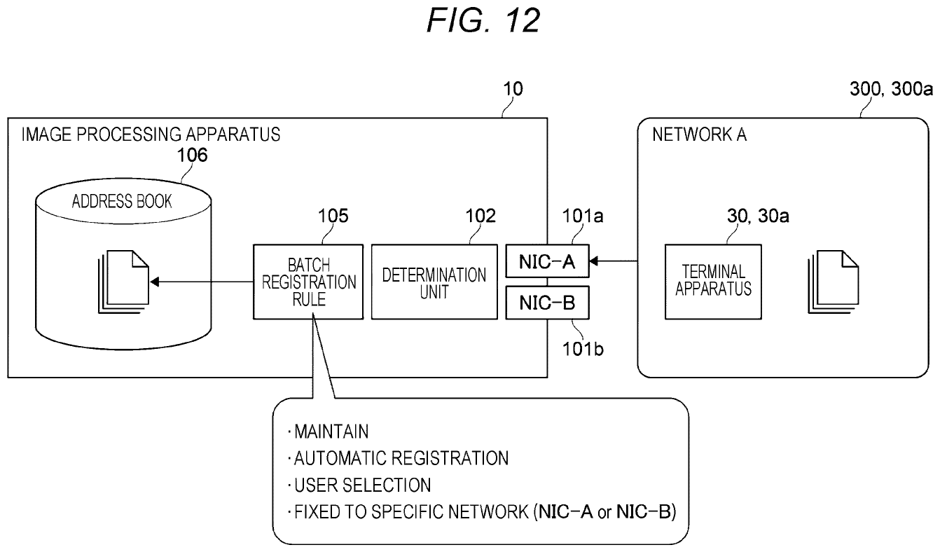

FIG. 12 is a diagram schematically illustrating destination registration processing of an image processing system 1 according to a fourth exemplary embodiment.

There are cases where an administrator of the image processing apparatus 10 remotely connects to the image processing apparatus 10 using the terminal apparatus 30, and registers the destination 31 by performing batch registration in a manner of importing a file backed up from another image processing apparatus.

In such a case, in the image processing system 1 according to the fourth exemplary embodiment, the image processing apparatus 10 sets any one of “maintain”, “automatic registration”, “user selection”, and “fixed to specific network” as a registration rule (hereinafter, referred to as “batch registration rule”) 105 of a network in batch registration, when the batch registration rule 105 is “maintain”, the image processing apparatus 10 registers the NIC 101 to which the network set in the backed-up file is connected as it is. When a network is not set for the backed-up file, the image processing apparatus 10 performs the destination registration processing of the first exemplary embodiment. When the batch registration rule 105 is “automatic registration”, the image processing apparatus 10 executes the destination registration processing of the first exemplary embodiment. That is, the image processing apparatus 10 overwrites the information on the NIC 101 included in the address book 106 with the information of the accessed NIC 101. When the batch registration rule is “user selection”, the user selects a NIC 101 to be used for overwriting at the time of batch registration with the terminal apparatus 30, and the image processing apparatus 10 registers the NIC 101 selected with the terminal apparatus 30 by the user. When the batch registration rule is “fixed to specific network”, the image processing apparatus 10 forcibly registers the NIC 101 to which a specific network is connected.

### (Functional Configuration of Image Processing Apparatus)

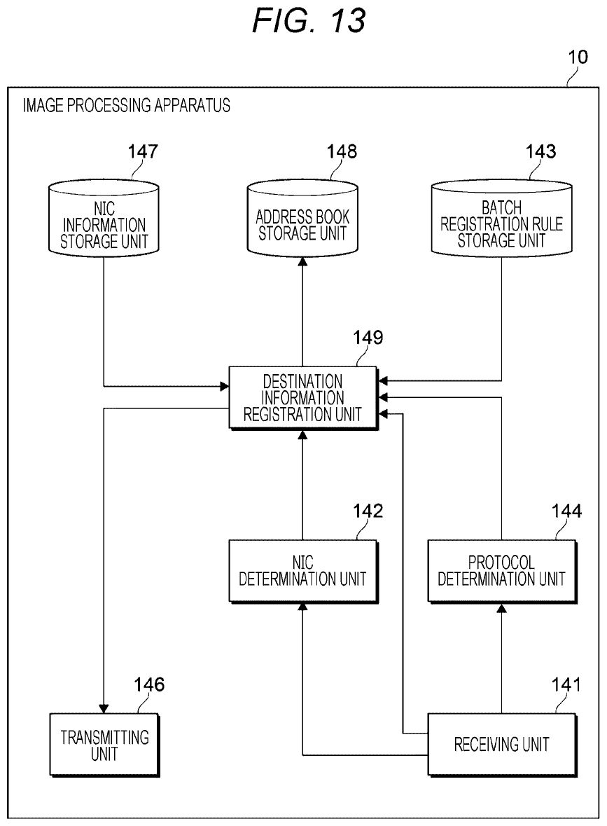

FIG. 13 is a block diagram illustrating an example of a functional configuration of the image processing apparatus 10 according to the fourth exemplary embodiment. As illustrated in the drawing, the image processing apparatus 10 includes a receiving unit 141, an NIC determination unit 142, a batch registration rule storage unit 143, an NIC information acquisition unit 144, a transmission unit 146, an NIC information storage unit 147, an address book storage unit 148, and a destination information registration unit 149.

The receiving unit 141 receives, from the terminal apparatus 30, a destination batch registration request to request batch registration of destinations on the address book stored in the address book storage unit 148 by importing a file backed up from another image processing apparatus. At this time, the terminal apparatus 30 transmits the destination batch registration request to the image processing apparatus 10 by accessing the NIC to which the network including the terminal apparatus 30 is connected among the plurality of NICs included in the image processing apparatus 10. Thus, the receiving unit 141 receives the destination batch registration request by using the accessed NIC. In the present exemplary embodiment, the processing in the receiving unit 141 is performed as an example of receiving a request to register a transmission destination of data using any of a plurality of network interfaces.

In addition to this, the receiving unit 141 receives information of the NIC selected by the user on the NIC selection screen displayed on the terminal apparatus 30. Here, the NIC selection screen is a screen for selecting an NIC that the user wants to register from among a plurality of NICs included in the image processing apparatus 10.

The NIC determination unit 142 has the same function as the NIC determination unit 112 in the first exemplary embodiment.

The batch registration rule storage unit 143 stores a batch registration rule used when batch registration of destination information including a destination and information of an NIC is performed on the address book stored in the address book storage unit 148 by importing a file backed up from another image processing apparatus. Here, as described above, the batch registration rules include “maintain”, “user selection”, and “fixed to specific network”.

When the batch registration rule stored in the batch registration rule storage unit 143 is “maintain”, the NIC information acquisition unit 144 acquires information of an NIC as long as the NIC is set in the file backed up from another image processing apparatus.

When the batch registration of destinations on the address book stored in the address book storage unit 148 is completed, the transmission unit 146 transmits the completion of the batch registration to the terminal apparatus 30 that has transmitted the destination batch registration request.

In addition, when the batch registration rule stored in the batch registration rule storage unit 143 is “user selection”, the transmission unit 146 transmits a command to display the NIC selection screen to the terminal apparatus 30 that has transmitted the destination batch registration request.

The address book storage unit 148 has the same function as the address book storage unit 118 in the first exemplary embodiment.

The destination information registration unit 149 creates destination information by setting, for each destination included in the destination batch registration request received by the receiving unit 141, information on the NIC to be used when data is transmitted to each destination, and registers the destination information on the address book stored in the address book storage unit 148.

For example, it is assumed that the batch registration rule stored in the batch registration rule storage unit 143 is “maintain”. In this case, the destination information registration unit 149 sets, for each destination, the information of the NIC acquired by the NIC information acquisition unit 144 as the information of the NIC to be used when data is transmitted to each destination, and registers the destination information. In the present exemplary embodiment, this processing in the destination information registration unit 149 is performed as an example of performing third registration processing of registering, among the plurality of network interfaces, a network interface that has been used for transmission of data to the specific transmission destination in the other information processing system as a network interface that is used for transmission of data to the specific transmission destination in the own system, when an instruction to perform the third registration processing is given.

It is also assumed that the batch registration rule stored in the batch registration rule storage unit 143 is “automatic registration”. In this case, the destination information registration unit 149 sets, for each destination, the information of the NIC determined by the NIC determination unit 142 as the information of the NIC to be used when data is transmitted to each destination, and registers the destination information. In the present exemplary embodiment, this processing in the destination information registration unit 149 is performed as an example of performing the (first) registration processing when an instruction to perform the (first) registration processing is given.

Further, it is assumed that the registration rule stored in the batch registration rule storage unit 143 is other than “automatic registration”. In this case, the destination information registration unit 149 sets, for each destination, information of another NIC as information of the NIC to be used when data is transmitted to each destination, and registers the destination information.

Here, various registration rules other than “automatic registration” are conceivable, but also in the following description, as described above, “user selection” and “fixed to specific network” are considered.

First, it is assumed that the batch registration rule stored in the batch registration rule storage unit 143 is “user selection”. In this case, the destination information registration unit 149 sets, for each destination, the information of the NIC selected by the user and received by the receiving unit 141 as the information of the NIC to be used when data is transmitted to each destination, and registers the destination information.

It is also assumed that the batch registration rule stored in the batch registration rule storage unit 143 is “fixed to specific network”. In this case, the destination information registration unit 149 sets, for each destination, the information of the NIC stored in the NIC information storage unit 147 as the information of the NIC to be used when data is transmitted to each destination, and registers the destination information.

### (Operation of Image Processing Apparatus)

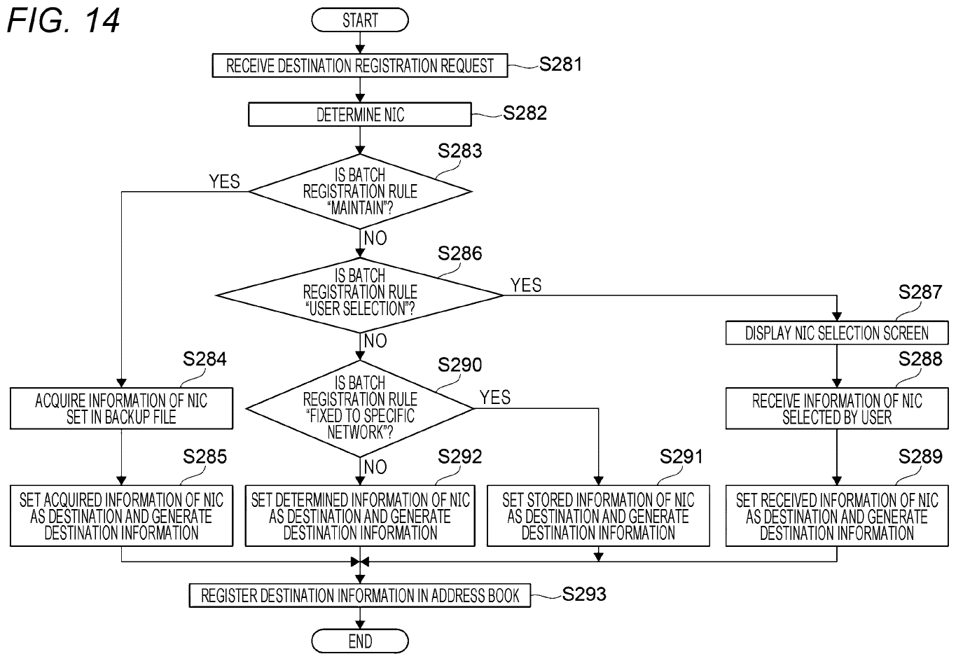

FIG. 14 is a flowchart illustrating an operation example of the image processing apparatus 10 according to the fourth exemplary embodiment.

In the image processing apparatus 10, first, the receiving unit 141 receives, from the terminal apparatus 30, a destination batch registration request to request batch registration of destinations on the address book stored in the address book storage unit 148 (step 281). Such a batch registration of destinations may be performed, for example, by importing a file backed up from another image processing apparatus.

Then, the NIC determination unit 142 determines the NIC accessed when the destination batch registration request is received in step 281 (step 282).

Next, the destination information registration unit 149 determines whether the batch registration rule stored in the batch registration rule storage unit 143 is “maintain” (step 283).

It is assumed that it is determined in step 283 that the batch registration rule is “maintain”. In such a case, the NIC information acquisition unit 144 acquires information of the NIC set for the file backed up from another image processing apparatus (step 284). Although it is conceivable that the information of the NIC is not set in the backed-up file, it is assumed here that the information of the NIC is set. Thereafter, the destination information registration unit 149 creates destination information by setting the information of the NIC acquired in step 284 to each destination included in the destination batch registration request received in step 281 (step 285).

On the other hand, it is assumed that it is determined in step 283 that the batch registration rule is not “maintain”. In such a case, the destination information registration unit 149 determines whether the batch registration rule stored in the batch registration rule storage unit 143 is “user selection” (step 286).

It is assumed that it is determined in step 286 that the batch registration rule is “user selection”. In such a case, the transmission unit 146 transmits a command to display the NIC selection screen to the terminal apparatus 30 that has transmitted the destination batch registration request (step 287). Then, the receiving unit 141 receives information of the NIC selected by the user on the NIC selection screen displayed on the terminal apparatus 30 (step 288). Thereafter, the destination information registration unit 149 creates destination information by setting the information of the NIC received in step 288 to each destination included in the destination batch registration request received in step 281 (step 289).

On the other hand, it is assumed that it is determined in step 286 that the batch registration rule is not “user selection”. In such a case, the destination information registration unit 149 determines whether the batch registration rule is “fixed to specific network” (step 290).

It is assumed that it is determined in step 290 that the batch registration rule is “fixed to specific network”. In such a case, the destination information registration unit 149 creates destination information by setting the information of the NIC stored in the NIC information storage unit 147 to each destination included in the destination batch registration request received in step 281 (step 291).

On the other hand, it is assumed that it is determined in step 290 that the batch registration rule is not “fixed to specific network”. In such a case, the destination information registration unit 149 creates destination information by setting the information of the NIC determined in step 282 to each destination included in the destination batch registration request received in step 281 (step 292).

Thereafter, the destination information registration unit 149 registers the destination information created in step 285, step 289, step 291, or step 292 on the address book stored in the address book storage unit 148 (step 293).

### Modification Example

Although a network interface is set for each destination in the first to fourth exemplary embodiments, the present invention is not limited to this configuration. A network interface may be set for a category (group) in which a plurality of destinations are collected.

For example, the image processing apparatus 10 may be able to associate a network interface with a category when creating the category in the address book, and use the network interface associated with the category when transmitting data to a destination in the category.

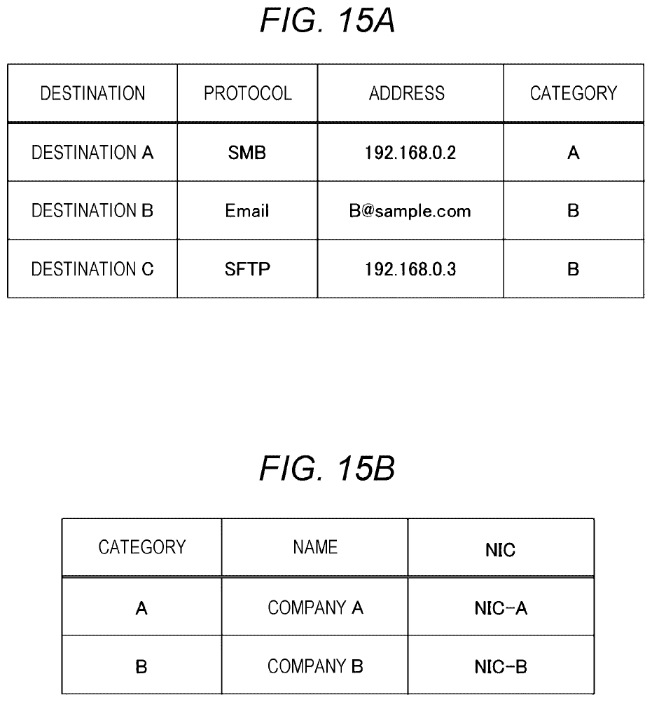

FIGS. 15A and 15B are diagrams illustrating a specific example of an address book in this modification example.

In FIG. 15A, a category is set in addition to the protocol and the address for each destination.

In FIG. 15B, a name and an NIC are set for each category. Here, the category “A” is a category in which destinations in a company A are collected, and the category “B” is a category in which destinations in a company B are collected. It is indicated that the NIC-A is used to transmit data to the network in the company A, and the NIC-B is used to transmit data to the network in the company B.

When the above-described configuration is applied to the first exemplary embodiment, in the image processing apparatus 10, first, the receiving unit 111 receives a category creation request to request creation of a category of the destinations in the address book stored in the address book storage unit 118. At this time, the receiving unit 111 receives the category creation request by using any of the plurality of NICs included in the image processing apparatus 10. Next, the NIC determination unit 112 determines the NIC accessed when the receiving unit 111 receives the category creation request. Next, the destination information registration unit 119 sets the NIC determined by the NIC determination unit 112 for the category created in response to the category creation request received by the receiving unit 111. Thereafter, the transmission unit 116 transmits data to a certain destination by using the NIC set to the category including the destination.

The above-described configuration is applicable to the second to fourth exemplary embodiments in the same manner.

In this case, the processing in the receiving units 111, 121, 131, and 141 is an example of receiving a request to create a group of transmission destinations by using any of a plurality of network interfaces.

The processing in the destination information registration units 119, 129, 139, and 149 is an example of registering, among a plurality of network interfaces, a network interface that has been used to receive a request to create a particular group, in association with the particular group.

Further, the processing in the transmission units 116, 126, 136, and 146 is an example of transmitting data to a transmission destination included in a particular group by using the network interface registered in association with the particular group.

Although the terminal apparatus 30 connects to the image processing apparatus 10 from a web browser and registers the network interface in the first to fourth exemplary embodiments, the present invention is not limited to this configuration. The terminal apparatus 30 may connect to the image processing apparatus 10 from a driver or an application installed in the terminal apparatus 30 to register the network interface. The batch registration of destinations described in the fourth exemplary embodiment can be executed using, for example, a destination batch registration tool, and such a destination batch registration tool is a typical example thereof.

### [Processor]

In the present exemplary embodiment, the processor refers to a processor in a broad sense, and includes general-purpose processors (for example, CPU: central processing unit) and dedicated processors (for example, GPU: graphics processing unit, ASIC: application specific integrated circuit, FPGA: field programmable gate array, and programmable logic devices).

The operation of the processor in the present exemplary embodiment may be performed not only by one processor but also by a plurality of processors existing at physically distant positions in cooperation with each other. In addition, the order of the operations of the processor is not limited to the order described in the present exemplary embodiment, and may be changed.

### [Program]

The processing performed by the image processing apparatus 10 according to the present exemplary embodiment is prepared as, for example, a program such as application software.

In this case, a program that realizes the present exemplary embodiment is regarded as a program for causing a computer to execute: a function of receiving a request to register a transmission destination of data by using any of a plurality of network interfaces; and a function of performing registration processing for registering, as a network interface to be used in transmission of data to a specific transmission destination, a network interface that has been used for reception of a request to register the specific transmission destination among the plurality of network interfaces.

The program that realizes the exemplary embodiment can be provided not only by a communication method but also by being stored in a recording medium such as a CD-ROM.

### [Supplementary Note]

(((1)))

An information processing system comprising at least one processor,
wherein the at least one processor receives a request to register a transmission destination of data by using any of a plurality of network interfaces, and performs registration processing for registering a network interface used for reception of a request to register a specific transmission destination among the plurality of network interfaces as a network interface to be used for transmission of data to the specific transmission destination.
   (((2)))

The information processing system according to (((1))), wherein
the at least one processor performs the registration processing when an instruction to perform the registration processing is given, and performs a second registration processing different from the registration processing when an instruction to perform the second registration processing is given.
   (((3)))

The information processing system according to (((2))), wherein
the second registration processing is processing for registering a network interface selected by a user in the request to register the specific transmission destination among the plurality of network interfaces as the network interface to be used for transmission of data to the specific transmission destination.
   (((4)))

The information processing system according to (((2))), wherein
the second registration processing is processing for registering a predetermined network interface among the plurality of network interfaces as the network interface to be used for transmission of data to the specific transmission destination.
   (((5)))

The information processing system according to (((1))), wherein
the at least one processor identifies a protocol to be used for transmission of data to the specific transmission destination, performs the registration processing when the protocol is a first protocol, and performs a second registration processing different from the registration processing when the protocol is a second protocol different from the first protocol.
   (((6)))

The information processing system according to (((5))), wherein
the second registration processing is processing for registering a network interface selected by a user in the request to register the specific transmission destination among the plurality of network interfaces as the network interface to be used for transmission of data to the specific transmission destination.
   (((7)))

The information processing system according to (((5))), wherein
the second registration processing is processing for registering a predetermined network interface among the plurality of network interfaces as the network interface to be used for transmission of data to the specific transmission destination.
   (((8)))

The information processing system according to any one of (((1))) to (((7))), wherein
the at least one processor performs the registration processing when an instruction to perform the registration processing is given, and performs a third registration processing for registering a network interface used in transmission of data to the specific transmission destination in another information processing system among the plurality of network interfaces as the network interface to be used for transmission of data to the specific transmission destination in an own system, when an instruction to perform the third registration processing is given.
   (((9)))

The information processing system according to any one of (((1))) to (((8))), wherein
the at least one processor receives a request to create a group of the transmission destination by using any of the plurality of network interfaces, and registers a network interface used in reception of a request to create a particular group among the plurality of network interfaces in association with the particular group.
   (((10)))

The information processing system according to (((9))), wherein
the at least one processor transmits data to the transmission destination included in the particular group by using the network interface registered in association with the particular group.
   (((11)))

A non-transitory computer-readable storage medium storing a program for causing a computer to execute: a function of receiving a request to register a transmission destination of data by using any of a plurality of network interfaces; and a function of performing registration processing for registering a network interface used for reception of a request to register a specific transmission destination among the plurality of network interfaces as a network interface to be used for transmission of data to the specific transmission destination.

What is claimed is:

1. An information processing system comprising at least one processor,
wherein the at least one processor receives a request to register a transmission destination of data by using any of a plurality of network interfaces, and performs registration processing for registering a network interface used for reception of a request to register a specific transmission destination among the plurality of network interfaces as a network interface to be used for transmission of data to the specific transmission destination.

2. The information processing system according to claim 1, wherein
the at least one processor performs the registration processing when an instruction to perform the registration processing is given, and performs a second registration processing different from the registration processing when an instruction to perform the second registration processing is given.

3. The information processing system according to claim 2, wherein
the second registration processing is processing for registering a network interface selected by a user in the request to register the specific transmission destination among the plurality of network interfaces as the network interface to be used for transmission of data to the specific transmission destination.

4. The information processing system according to claim 2, wherein
the second registration processing is processing for registering a predetermined network interface among the plurality of network interfaces as the network interface to be used for transmission of data to the specific transmission destination.

5. The information processing system according to claim 1, wherein
the at least one processor identifies a protocol to be used for transmission of data to the specific transmission destination, performs the registration processing when the protocol is a first protocol, and performs a second registration processing different from the registration processing when the protocol is a second protocol different from the first protocol.

6. The information processing system according to claim 5, wherein
the second registration processing is processing for registering a network interface selected by a user in the request to register the specific transmission destination among the plurality of network interfaces as the network interface to be used for transmission of data to the specific transmission destination.

7. The information processing system according to claim 5, wherein
the second registration processing is processing for registering a predetermined network interface among the plurality of network interfaces as the network interface to be used for transmission of data to the specific transmission destination.

8. The information processing system according to claim 1, wherein
the at least one processor performs the registration processing when an instruction to perform the registration processing is given, and performs a third registration processing for registering a network interface used in transmission of data to the specific transmission destination in another information processing system among the plurality of network interfaces as the network interface to be used for transmission of data to the specific transmission destination in an own system, when an instruction to perform the third registration processing is given.

9. The information processing system according to claim 1, wherein
the at least one processor receives a request to create a group of the transmission destination by using any of the plurality of network interfaces, and registers a network interface used in reception of a request to create a particular group among the plurality of network interfaces in association with the particular group.

10. The information processing system according to claim 9, wherein
the at least one processor transmits data to the transmission destination included in the particular group by using the network interface registered in association with the particular group.

11. A non-transitory computer-readable storage medium storing a program for causing a computer to execute: a function of receiving a request to register a transmission destination of data by using any of a plurality of network interfaces; and a function of performing registration processing for registering a network interface used for reception of a request to register a specific transmission destination among the plurality of network interfaces as a network interface to be used for transmission of data to the specific transmission destination.
